(19) United States
(12) Patent Application Publication
(10) Pub. No.: US 2009/0104444 A1
(43) Pub. Date: Apr. 23, 2009

(54) HALOGEN-FREE FLAME RETARDANT ADHESIVE COMPOSITIONS AND ARTICLE CONTAINING SAME

(75) Inventors: Rafael Garcia-Ramirez, Austin, TX (US); Eumi Pyun, Austin, TX (US); Ralph Su, Yang Mei (TW); Emily Liao, Yangmei (TW)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/875,701

(22) Filed: Oct. 19, 2007

(51) Int. Cl. B32B 7/12; C09K 21/00

(52) U.S. Cl. 428/346; 252/602; 428/343; 428/356

(57) ABSTRACT

Flame retardant adhesives and adhesive tape articles include a halogen-free flame retardant composition comprising a phosphinate or phosphinate salt. The halogen-free flame retardant compositions can also include additional materials, such as alumina trihydrate and magnesium hydroxide, that are substantially free of halogenated compounds or materials.

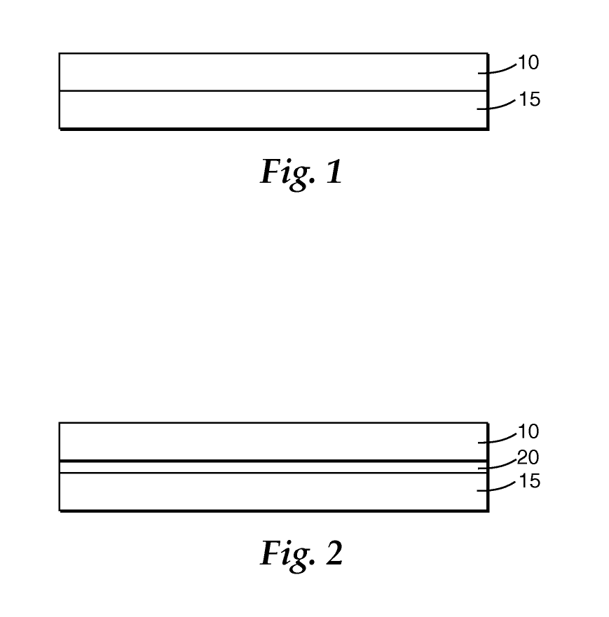

### BACKGROUND

The present invention relates to flame retardant adhesive compositions and adhesive tape articles. Adhesives and adhesive tape articles are used in many industries and for many different purposes. Adhesives and adhesive tape articles are commonly used, for example, in the electrical industry as insulating tapes and in myriad other applications. In many such applications, there exists a desire, or even a need, for flame resistance or flame retardancy. The most widely known and used flame retardant materials and additives utilize one or more halogen-containing (e.g., bromine- or chlorine-containing) compounds. Increased environmental and safety scrutiny, however, drives a movement to reduce or eliminate the presence of halogenated and halogen-containing materials in many industrial and consumer products. Currently available non-halogenated or halogen-free adhesives and adhesive tape articles fail to demonstrate an ability to offer desired flame resistance and flame retardant properties, pass industry standard UL 510 testing and achieve a Comparative Tracking Index (“CTI”) Rating of I.

### SUMMARY

Briefly, in one aspect, the present invention provides adhesive compositions useful, for example, in the construction of a tape article. The adhesive compositions include a halogen-free flame retardant composition. The halogen-free flame retardant composition includes a phosphinate (or phosphinate salt) and, optionally, one or more other non-halogenated flame retardant materials such as, for example, alumina trihydrate and magnesium hydroxide.

In other aspects, the invention provides articles that comprise a tape. The tape includes at least one adhesive composition and one or more backing materials. The adhesive composition and/or the backing material can include a halogen-free flame retardant composition. The halogen-free flame retardant composition includes a phosphinate (or phosphinate salt) and, optionally, one or more other non-halogenated flame retardant materials such as, for example, alumina trihydrate and magnesium hydroxide.

In still other aspects, the invention provides various articles that include a tape article construction. The tape article constructions comprise an adhesive composition, a halogen-free flame retardant composition and a halogen-free backing material. The halogen-free flame retardant composition can be present in or incorporated into either or both the adhesive composition and the backing material. The halogen-free flame retardant composition may also be present as or incorporated into an independent structural or functional layer within the tape article constructions. The halogen-free flame retardant composition includes a phosphinate (or phosphinate salt) and, optionally, one or more other non-halogenated flame retardant materials such as, for example, alumina trihydrate and magnesium hydroxide.

In yet other aspects, the invention provides tape articles and adhesive compositions that during application and use exhibit flame retardant properties, pass industry standard UL 510 testing and achieve a Comparative Tracking Index (“CTI”) rating of I.

### DETAILED DESCRIPTION OF PREFERRED EMBODIMENTS

Briefly, embodiments of the present invention provide adhesive compositions and tape articles that comprise a composition that includes or incorporates one or more halogen-free flame retardants. The resistance of the flame retardant composition to flammability can be demonstrated by passing the flame retardant testing portion of industry standard UL 510 test. The flame retardant compositions contain substantially no amount of a halogenated or halogen-containing material. The halogen-free flame retardant compositions generally comprise a phosphinate (or phosphinate salt). The flame retardant compositions may also include one or more additional non-halogenated flame retardant materials such as, for example, alumina trihydrate (Al₂O₃.3H₂O) or magnesium hydroxide (Mg(OH)₂).

In certain embodiments, the halogen-free flame retardant compositions of the invention include a phosphinate. The phosphinate can be in the form of, for example, a phosphinate salt. More particularly, the phosphinate can be incorporated into the flame retardant composition as a metal phosphinate salt. Suitable metal phosphinate salts include, for example, aluminum phosphinate salts and zinc phosphinate salts.

In other embodiments, the halogen-free flame retardant composition includes a blend composition that includes a phosphinate (or phosphinate salt) used together with one or more additional halogen-free flame retardant substances. Suitable such additional substances include, for example, alumina trihydrate (Al₂O₃.3H₂O) and magnesium hydroxide (Mg(OH)₂). When constituting a blend, the flame retardant compositions will generally comprise at least one phosphinate (or phosphinate salt) in an amount from about 17% to about 100% by weight of the flame retardant composition, and one or more additional flame retardant substances in an amount from about 0% to about 83% by weight of the flame retardant composition. The use of a phosphinate-containing flame retardant composition incorporated into an adhesive composition or an adhesive tape article shows advantageous properties and characteristics required to pass industry standard UL 510 flammability testing and achieve a Comparative Tracking Index (“CTI”) rating of I.

In various embodiments of the invention, the halogen-free flame retardant composition is blended or combined with an adhesive material. Because of the general desire to minimize or eliminate halogenated materials from commercial and consumer products, the adhesive materials into which the flame retardant compositions are incorporated are preferably also substantially free of halogen-containing compounds. Useful adhesive compositions include myriad different types and forms of adhesives. In describing a suitable adhesive by its properties or characteristics, adhesives such as pressure sensitive adhesives, thermoset adhesives, hot-melt adhesives, and other types of adhesives can be used. In describing a suitable adhesive by its relative chemical composition, adhesives such as acrylic adhesives, polyolefin adhesives, styrenic co-polymer adhesives, silicone adhesives, epoxy adhesives, ethylene co-polymer adhesives, and other types of adhesives can be used. The halogen-free flame retardant compositions of the invention can be incorporated into such adhesive materials to impart desired flame retardant and flame resistant properties to the adhesives.

Adhesives incorporating the flame retardant compositions of the invention may be used in any application for which the underlying adhesive is intended and for which a degree of flame retardency and flame resistance is desired. The halogen-free flame retardant compositions of the invention find particular utility in the construction of tape articles. Such tape articles generally comprise a backing material onto which one or more functional or structural layers are applied (typically by coating). One or more of the halogen-free flame retardant compositions of the invention may be used in or with such tape articles by incorporating the compositions into the backing material and/or one or more of the functional or structural layers. The flame retardant composition may, for example, be incorporated into an adhesive composition which is applied to a backing material, or it may be applied as, or together with, a non-adhesive layer within the tape article construction independent of an adhesive layer. It may also be incorporated directly into the backing material alone or in combination with its incorporation into one or more of the functional or structural layers of the overall tape construction. There is, therefore, great flexibility in the utility of the flame retardant compositions of the invention within a tape article construction.

The halogen-free flame retardant compositions can comprise, for example, solely one or more phosphinate compounds or a blend of one or more phosphinate compounds with one or more additional flame retardant compounds (e.g., alumina trihydrate or magnesium hydroxide). The flame retardant compositions may also be used in adhesive compositions or tape articles together with other materials. Many adhesive compositions, for example, include one or more cross-linking compositions such as, for example, a bis-amide. Adhesive and tape articles also often incorporate one or more tackifier compounds to manage a desired tack characteristic of the adhesive or tape. Other customary additives, adjuvants, agents and materials (e.g., colorants, pigments, primers, fillers, uv absorbers, conductive particles, etc.) are understood by those skilled in the art.

In one illustrative embodiment of the invention, a multi-layered tape article includes a halogen-free flame retardant adhesive composition of the invention applied to a backing material. In this case, an adhesive composition contains the halogen-free flame retardant composition as a layer applied to a backing material. Such an adhesive layer can be of any desired and workable thickness, but is generally in the range from about 12 μm to about 80 μm or possibly more. The backing material is, preferably, free of halogen-containing compounds. Suitable backing materials include, for example: polymer materials such as polyesters (e.g., PET (polyethylene terephthalate), polyolefins, polyamides and polyimides; natural and synthetic rubber materials; paper materials; metal foils, glass cloths; and other types of materials. The backing can be of any desired and workable thickness, but is generally between about 25 μm and about 125 μm thick.

Tape articles that include the halogen-free compositions of the invention can include a primer disposed between the adhesive composition and the backing. A suitable primer is commercially available as 3M™ P-93 Primer from 3M Company of Saint Paul, Minn., USA. Tape articles can also be constructed to include a low adhesion backing (or “LAB”) material on the side of the backing opposite the side including the adhesive composition and, if present, the primer. The low adhesion backing material helps prevent individual pieces of tape from adhering to each other when a roll is manufactured and wound. Suitable LAB materials include urethane polymers such as 3M™ RD-1547 Urethane Polymer Solution from 3M Company of Saint Paul, Minn., USA.

### EXAMPLES

The following examples and comparative examples are offered to aid in the understanding of the present invention and are not to be construed as limiting the scope thereof. Unless otherwise indicated, all parts and percentages are by weight. The following test methods and protocols were employed in the evaluation of the illustrative and comparative examples that follow:

### Test Methodologies

### 1. UL 510 Flammability Test:

A specimen is exposed to an open flame for a period of fifteen seconds. Upon exposure to the flame, any flame on the test specimen (which typically catches fire) must extinguish in less than 60 seconds to pass the test. The test is repeated five times. Any extinguishing time longer than 60 seconds is considered a failure for the specimen. Results are reported as “Pass” or “Fail.” Further information regarding the test may be found in the description of the UL 510 standard published by Underwriters Laboratory of Northbrook, Ill., USA.

### 2. Dry and Wet Dielectric Strength:

Testing for dry and wet dielectric strength was performed according to the protocol of ASTM D149. In general, according to this test a sample is placed between two electrodes and power is increased until there is a dielectric failure. Testing for “dry” dielectric strength was performed at room temperature and 50% relative humidity. Testing for “wet” dielectric strength was performed upon exposure of the sample for 96 hours at 23° C. and 96% relative humidity. To pass the dry dielectric strength test, the dielectrics must be greater than or equal to 1000 V/mil. To pass the wet dielectric strength test, at least 90% of the dry dielectric strength must be retained (i.e., the wet dielectrics are greater than or equal to 900 V/mil).

### 3. Comparative Tracking Index (“CTI”):

The Comparative Tracking Index (or “CTI”) of a material is a measure of the resistance of a material to surface tracking under defined test conditions. The protocol for the test is set forth in ASTM D3638-07. In general, to perform the test the upper surface of a test specimen is supported in an approximately horizontal plane and subjected to an electrical stress via two electrodes. The surface between the electrodes is subjected to a succession of drops of an electrolyte solution until the over-current device operates, until a persistent flame occurs or until the testing period has elapsed. Individual tests are of short duration (less than 1 hour) with up to 50 or 100 drops of about 20 mg of electrolyte solution falling at 30 second intervals between platinum electrodes spaced 40 mm apart on the test specimen surface. An alternating current voltage between 100 V and 600 V is applied to the electrodes during the test.

Results are plotted to record the number of drops of electrolyte solution placed on the surface of the specimen versus the recorded voltage. The Comparative Track Index, or CTI, represents the voltage corresponding to 50 drops of electrolyte solution. The lower the CTI rating for a given material, the greater is the creepage distance associated with that material. A CTI Rating is given as follows:
CTI Rating I: CTI≧600 V
CTI Rating II: 400 V≦CTI<600 V
CTI Rating IIIa: 175 V≦CTI<400 V
CTI Rating IIIb: 100 V≦CTI<175 V

### 4. UL 510 Adhesion to Steel:

The UL 510 Adhesion to Steel standard requires an adhesion value of at least 16 oz/in (18 g/mm) measured according to ASTM D1000.

### 5. Opacity:

Opacity was tested according to ASTM D589-97. In general, to perform the test a film sample is placed on a black/white contrast chart. After air-drying, the drawdown of a sample is objectively evaluated using a BYK-Gardner type spectrometer guide. Results are reported as percent opacity, calculated as:

Y_{Black}/Y_{White}×100%

### Comparative Examples C1 to C3

Tape samples were constructed to illustrate the performance of several known flame retardant compositions. For each comparative example, an acrylic adhesive polymer (3M™ Product No. 21-3314-0004-0, from 3M Company, Saint Paul, Minn., USA) was combined with a flame retardant composition as indicated in Table 1 below. In each case the mixture comprised between 30 and 40 wt % of the flame retardant. The ingredients were mixed using a laboratory-size high intensity mixer in the presence of a solvent (heptane, ethyl acetate or a blend of both). The mixed adhesive composition was coated directly onto a primed 25 μm thick PET film using either a laboratory knife-coater to produce handspread samples or a pilot-size coater (equipped with a knife-coater) to produce a continuous coated film with a nominal coating thickness of about 25 μm. After coating, the samples were either placed in a forced-convection oven (in the case of the handspread samples) or continuously passed through a tunnel oven (in the case of the continuous film) to extract the solvent and dry the sample. The coated and dried samples were then cut or slit to produce 0.75 inch (1.9 cm) samples. The samples were subjected to the test methodologies described above and the results are provided in Table 1 below.

TABLE 1

| | | | UL 510 Dielectric | |
|---|---|---|---|---|
| Comparative | | UL 510 | Breakdown | CTI |
| Example | Flame Retardant | Flammability | (% Retention) | Rating |
| C1 | Decabromo di-phenyl ethane | PASS | PASS | II |
| | (Saytex ™ 8010 from Albermarle Co., Baton | | | |
| | Rouge, LA, USA) | | | |
| C2 | Ammonium polyphosphate | PASS | FAIL | IIIa |
| | (Product “S XS10 from Budenheim Iberica | | | |
| | Co., Zaragoza, Spain) | | | |
| C3 | Polyphosphoric acid salt | PASS | FAIL | IIIa |
| | (Zuran ™ 484 from Chitec Technology Corp., | | | |
| | Taipei, Taiwan) | | | |

Each of Comparative Examples C1 to C3, as shown in Table 1 above, exhibit acceptable UL 510 flammability performance. Comparative Example C1, which includes a halogen-containing flame retardant, passes the UL 510 Dielectric Breakdown test but exhibits a CTI Rating of only II (thereby failing to achieve a CTI Rating of I). Comparative Examples C2 and C3, which each contains a non-halogenated flame retardant, fail to pass the UL 510 Dielectric Breakdown test and achieve a CTI Rating of only IIIa (thereby also failing to achieve a CTI Rating of I).

### Examples 1-9 and Comparative Examples C4 to C7

Tape samples were constructed to illustrate various embodiments of the invention. To prepare tape samples for a given example or comparative example, an adhesive composition was prepared containing the ingredients identified in Table 2 below in the amounts identified in Table 3. For each sample, the ingredients for the adhesive composition were mixed using a laboratory-size high intensity mixer in the presence of a solvent (heptane, ethyl acetate or a blend of both). The resulting composition was coated directly onto a primed 25 μm thick PET film using either a laboratory knife-coater to produce handspread samples or a pilot-size coater (equipped with a knife-coater) to produce a continuous coated film with a nominal coating thickness of about 25 μm. After coating, the samples were either placed in a forced-convection oven (in the case of the handspread samples) or continuously passed through a tunnel oven (in the case of the continuous film) to extract the solvent and dry the sample. The coated and dried samples were then cut or slit to produce 0.75 inch (1.9 cm) samples. The samples were subjected to the test methodologies described above and the results are indicated in Table 3 below.

TABLE 2

| Adhesive Ingredient | Product Name | Source |
|---|---|---|
| Acrylic adhesive | 3M ™ Product | 3M Company, St. Paul, MN |
| polymer | Number | |
| | 21-3314-0004-0 | |
| Tackifier | RE80H | Arizona Chemical, USA |
| Aluminum | OP935 | Clariant, Germany |
| Phosphinate Salt | | |
| Alumina trihydrate | Hymod M932-SG | Huber, USA |
| TiO₂ | N/A | Dupont, Taiwan |
| Yellow pigment | 3M ™ Product | 3M Company, St. Paul, MN |
| | Number | |
| | 11-3313-5022-0 | |
| Bis-amide crosslinker | 3M ™ Product | 3M Company, St. Paul, MN |
| | Number | |
| | 41-4100-1054-4 | |

Film Backing Material

| | | |
|---|---|---|
| PET Film | Tairilin BP25 | Nan Ya, Taiwan |
| Primer | 3M ™ P-93 | 3M Company, St. Paul, MN |
| | Primer | |

TABLE 3

| | | | | | | | | | UL 510 | | |
|---|---|---|---|---|---|---|---|---|---|---|---|
| | | | | | | UL 510 | | UL 510 | Wet | | |
| | Ratio | | | | | Ad. | | Dielectric | Dielectric | Percent | |
| | Phosphinate | TiO₂ | Filler | Thickness | Opacity | to Steel | UL 510 | Breakdown | Breakdown | Retention | CTI |
| Example | to ATH | (phr)¹ | (phr)^{1,2} | (μm)³ | (%) | (oz/in) | Flamm. | (kV) | (kV) | (90% min) | Rating |
| 1 | 100/0 | 0 | 40.2 | 51 | 3 | 24 | PASS | 5.63 | 5.02 | 90% | I |
| | | | | | | | | | | (PASS) | |
| 2 | 100/0 | 12.1 | 45.8 | 60 | 73 | 29 | PASS | 6.13 | 6.20 | 101% | I |
| | | | | | | | | | | (PASS) | |
| 3 | 81/19 | 11.8 | 55.0 | 54 | 64 | 25 | PASS | 6.26 | 6.24 | 100% | I |
| | | | | | | | | | | (PASS) | |
| 4 | 71/29 | 0 | 43.3 | 50 | 2 | 32 | PASS | 6.06 | 5.86 | 97% | I |
| | | | | | | | | | | (PASS) | |
| 5 | 68/32 | 0 | 40.1 | 74 | 5 | 40 | PASS | 6.06 | 6.0 | 99.8% | I |
| | | | | | | | | | | (PASS) | |
| 6 | 50/50 | 0 | 54.0 | 62 | 5 | 30 | PASS | 5.72 | 6.2 | 108.9% | I |
| | | | | | | | | | | (PASS) | |
| 7 | 40/60 | 0 | 67.0 | 62 | 3 | 31 | PASS | 5.57 | 5.8 | 103.9% | I |
| | | | | | | | | | | (PASS) | |
| 8 | 30/70 | 0 | 90.0 | 63 | 4 | 27 | PASS | 6.07 | 6.0 | 99.4% | I |
| | | | | | | | | | | (PASS) | |
| 9 | 20/80 | 0 | 137.0 | 57 | 5 | 18 | PASS | 5.77 | 6.3 | 108.4% | I |
| | | | | | | | | | | (PASS) | |
| C4 | 15/85 | 0 | 180.0 | 77 | 8 | 7 (FAIL) | PASS | 6.83 | 8.3 | 121.5% | I |
| | | | | | | | | | | (PASS) | |
| C5 | 11/90 | 0 | 185.0 | 50 | 7 | 0.2 (FAIL) | FAIL | 6.47 | 6.1 | 101.2% | I |
| | | | | | | | | | | (PASS) | |
| C6 | 0/100 | 0 | 80.3 | 65 | 5 | 38 | FAIL | 5.92 | 6.25 | 105.6% | I |
| | | | | | | | | | | (PASS) | |
| C7 | 0/100 | 0 | 162 | 50 | 5 | 4 (FAIL) | FAIL | 6.07 | 6.1 | 94% | I |
| | | | | | | | | | | (PASS) | |

¹On the basis of adhesive + tackifier
²Total filler concentration, including flame retardant and TiO₂
³Thickness of the whole tape construction

Examples 1-9 demonstrate that incorporation of a halogen-free flame retardant composition according to embodiments of the invention that include a phosphinate salt alone or in combination with alumina trihydrate into a tape article construction impart favorable physical properties. Each of these examples pass industry standard UL 510 flammability and dielectric breakdown testing (i.e., the wet dielectric strength is at least 90% of the dry dielectric strength). Each also achieves a CTI rating of I. The illustrated examples also offer flexibility, with the inclusion of additional additives, to control the level of adhesion and opacity of the tape articles into which the flame retardant compositions are incorporated. Flame retardant compositions that include both a phosphinate and alumina trihydrate at a ratio of less than about 17% phosphinate by weight of the flame retardant composition require higher levels of the blended flame retardant to be present in the adhesive composition to achieve a desired level of flame resistance. This generally negatively affects the adhesive properties of the adhesive composition and are therefore not preferred.

Although the aforementioned detailed description contains many specific details for purposes of illustration, one of ordinary skill in the art will appreciate that many variations, changes, substitutions, and alterations to the details are within the scope of the invention as claimed. Accordingly, the invention described in the detailed description is set forth without imposing any limitations on the claimed invention. The proper scope of the invention should be determined by the following claims and their appropriate legal equivalents.

1. A halogen-free, flame retardant adhesive composition comprising at least one adhesive and a halogen-free flame retardant composition comprising a phosphinate or phosphinate salt.

2. The adhesive composition of claim 1 wherein the flame retardant composition further comprises at least one additional material which is substantially free of halogen-containing compounds.

3. The adhesive composition of claim 2 wherein the at least one additional material includes alumina trihydrate.

4. The adhesive composition of claim 2 wherein the at least one additional material includes magnesium hydroxide.

5. The adhesive composition of claim 1 wherein the phosphinate salt is a metal phosphinate salt.

6. The adhesive composition of claim 5 wherein the metal phosphinate salt is an aluminum phosphinate salt or a zinc phosphinate salt.

7. The adhesive composition of claim 1 wherein the adhesive is selected from the group consisting of: pressure-sensitive adhesives, thermoset adhesives, and hot melt adhesives.

8. The adhesive composition of claim 1 wherein the adhesive is selected from the group consisting of: acrylic adhesives, polyolefin adhesives, styrenic co-polymer adhesives, silicone adhesives, epoxy adhesives, and ethylene co-polymer adhesives.

9. The adhesive composition of claim 2 wherein the phosphinate or phosphinate salt comprises from about 17% to about 100% by weight of the flame retardant composition and the at least one additional material comprises from about 0% to about 83% by weight of the flame retardant composition.

10. An article of manufacture comprising a tape comprising:
a backing material that is substantially free of a halogen-containing material;
an adhesive composition disposed on at least one face of the backing material; and
a halogen-free flame retardant composition comprising a phosphinate or phosphinate salt.

11. The article of claim 10 wherein the flame retardant composition further comprises at least one additional material which is substantially free of halogen-containing compounds.

12. The article of claim 11 wherein the at least one additional material includes alumina trihydrate.

13. The article of claim 11 wherein the at least one additional material includes magnesium hydroxide.

14. The article of claim 10 wherein the flame retardant composition is present in the adhesive composition disposed on at least one face of the backing material.

15. The article of claim 10 wherein the flame retardant composition is present in the backing material.

16. The article of claim 10 further comprising a primer disposed between the adhesive composition and the backing material.

17. The article of claim 10 further comprising a low adhesion backing disposed on the side of the backing material opposite from the adhesive composition.

18. The article of claim 10 further comprising at least one additional structural or functional layer disposed on at least one face of the backing material.

19. The article of claim 18 wherein the at least one additional structural or functional layer includes the flame retardant composition.

20. The article of claim 10 wherein the phosphinate salt is a metal phosphinate salt.

21. The article of claim 20 wherein the metal phosphinate salt is an aluminum phosphinate salt or a zinc phosphinate salt.

22. The article of claim 10 wherein the adhesive is selected from the group consisting of: pressure-sensitive adhesives, thermoset adhesives, and hot melt adhesives.

23. The article of claim 10 wherein the adhesive is selected from the group consisting of: acrylic adhesives, polyolefin adhesives, styrenic co-polymer adhesives, silicone adhesives, epoxy adhesives, and ethylene co-polymer adhesives.

24. The article of claim 10 wherein the backing material comprises a polyester, polyolefin, polyamide or polyimide polymeric material.

25. The adhesive composition of claim 11 wherein the phosphinate or phosphinate salt comprises from about 17% to about 100% by weight of the flame retardant composition and the at least one additional material comprises from about 0% to about 83% by weight of the flame retardant composition.
